(19) United States
(12) Patent Application Publication
(10) Pub. No.: US 2008/0017804 A1
(43) Pub. Date: Jan. 24, 2008

(54) Boron thin films for solid state neutron detectors

(76) Inventors: Viswanath Krishnamoorthy, Albuquerque, NM (US); Christopher James Eiting, Albuquerque, NM (US)

Correspondence Address: V. Gerald Grafe, Esq., P.O. Box 2689, Corrales, NM, 87048, US

(21) Appl. No.: 11/367,681

(22) Filed: Mar. 3, 2006

(51) Int. Cl. G01T 3/08

(52) U.S. Cl. 250/370.05

(57) ABSTRACT

The present invention provides methods and apparatuses for detecting neurons, that provide high sensitivity, low cost, durability, portability, and scalability. Neutrons interacting with a ¹⁰B layer in the present invention result in expression of alpha particles from the ¹⁰B layer. The alpha particles can then be detected, for example with a silicon photodetector or an imaging array (e.g., arrays used in digital cameras).

### BACKGROUND

The present invention relates to methods and apparatuses for detecting neutrons.

The need for radiation detectors has increased significantly in the wake of the 911 tragedy. Homeland security, military and intelligence agencies are concerned about the theft of radioactive materials by terrorist groups for use in “dirty bombs”. Theft and smuggling of weapons, and usable nuclear material is not a hypothetical concern, but an ongoing reality: International Atomic Energy Agency (IAEA) has documented 18 cases, confirmed by the states involved, of seizures of stolen plutonium or highly enriched uranium over the past decade. Homeland security spending has increased substantially, with significant emphasis on nuclear threat detection improvement. Nuclear detection instruments need to be in airports, borders, ports, and in the hands of first responders, law enforcement and customs agents internationally.

There are four forms of radiation: gamma, beta, alpha and neutron. Gamma and neutron detectors are extremely important for homeland security applications since these types of radiation cannot be easily shielded. Although gamma detectors are very common, detection of neutrons is valuable because they are the most penetrating radiation type that can be detected by homeland security instrumentation. There are also very few legal neutron sources, so the presence of neutrons makes it more likely that the radioactive material is associated with an illicit activity. Currently available neutron detectors are expensive, fragile, insensitive and cumbersome, need high operating voltages and often give false alarms.

Lithium-based neutron detectors generally have the lowest thermal neutron cross-section and hence the lowest sensitivity. Lithium scintillation detectors are made of lithium iodide crystals with an activator element. Since the detectors are solids, the density of lithium is high and hence the detector efficiency is better than gas based detectors. Lithium iodide crystals are extremely hygroscopic and cannot be exposed to water. Therefore, commercially available detectors are hermetically sealed in a thin canning material. The lithium iodide crystals are solids and hence these detectors are almost exclusively used in applications where volume is at a premium, such as pocket and pager sized neutron detectors. Neutron detectors using this technology are amongst the most inexpensive in the market.

Another detector consists of BF₃ gas in a tube that is enriched with ¹⁰B. The thermal neutron cross-section is much greater than that of the lithium reaction and hence the neutron sensitivity is much greater in these detectors. Since these detectors contain pressurized gas, all of the inherent disadvantages (leakage, robustness etc.) associated with such systems need to be addressed. Also, these proportional counters operate at significantly high voltages (2000-3000V). This tends to make the system a bit bulky. Also, BF₃ tubes share the temperamental qualities of proportional counters, such as spurious pulses from fluctuations in leakage currents through insulators and spurious counts when subjected to vibration and shock, hence registering false alarms. BF₃ counters also show significant degradation in performance over time.

Another detector technology uses a ³He reaction. Since the thermal neutron cross-section is the highest for the ³He reaction, it has the potential for the highest sensitivity for neutron detection. Unfortunately, since helium is a noble gas, no solid compounds can be fabricated and the material must remain in its natural gaseous form. Again, as in BF₃ gas detectors, issues such as leakage and robustness need to be addressed. These detectors operate at high voltages and need an elaborate power supply which, in turn, leads to a bulky system. ³He detectors are susceptible to spurious counts when subjected to vibration and shock hence registering false alarms. These detectors are the most prevalent of the neutron detectors and are used in hand-held units and portal monitors.

Accordingly, there is a need for methods and apparatuses for detecting neutrons that do not suffer from the disadvantages of current detectors.

### SUMMARY OF THE INVENTION

The present invention provides methods and apparatuses for detecting neutrons, that provide high sensitivity, low cost, durability, portability, and scalability. Neutrons interacting with a ¹⁰B layer in the present invention result in expression of alpha particles from the ¹⁰B layer. The alpha particles can then be detected, for example with a silicon photodetector or an imaging array (e.g., arrays used in digital cameras).

Embodiments of the present invention comprise a layer of ¹⁰B on a substrate. The substrate comprises a material that creates a chemical bond with the ¹⁰B layer sufficient to resist delamination of the ¹⁰B layer, with a ¹⁰B layer thicker than about 1 micron, processed at temperatures less than about 300° C. Previous attempts to use ¹⁰B layers generally require higher temperature processing, are limited to significantly thinner ¹⁰B layers, or both. The use of a substrate material that forms a bond of sufficient strength to maintain a 1 micron or thicker ¹⁰B layer, processed at relatively low temperatures, enables advantages of the present invention. The relatively thick ¹⁰B layer allows greater sensitivity than previous attempts using thin ¹⁰B layers. The substrate can comprise a compound of oxygen, carbon, nitrogen, or phosphorous. Example substrates include sapphire, soda lime glass, and borosilicate glass.

The present invention also contemplates use of an intermediate layer on a substrate, where the intermediate layer forms the desired chemical bond with the ¹⁰B layer, and mounts securely with the remainder of the substrate.

A detector sensitive to alpha particles, for example a silicon photodetector, can be mounted with the ¹⁰B layer such that alpha particles from the ¹⁰B layer interact with the detector. The detector can then generate signals, for example to an external alarm, display, or recorder. A moderator can be mounted with the ¹⁰B layer to reduce the energy of incoming neutrons. For example, HDPE can be mounted between the ¹⁰B layer and a source of neutrons. Neutrons encountering the HDPE material can be slowed by the HDPE, and more efficiently interact with the ¹⁰B layer, increasing the sensitivity of the detector.

The present invention also contemplates methods of detecting neutrons. In a method according to the present invention, substrates and ¹⁰B layers like those described above are provided. The ¹⁰B layer can be positioned relative to a source of neutrons such that at least some neutrons from the source interact with the ¹⁰B layer. Resulting alpha particles can be detected as an indicator of neutrons interacting with the ¹⁰B layer.

### DESCRIPTION OF THE FIGURES

The invention is explained by using embodiment examples and corresponding drawings, which are incorporated into and form part of the specification.

FIG. 1 is a schematic illustration of a neutron detector according to the present invention.

FIG. 2 is a schematic illustration of an example detector arrangement according to the present invention.

FIG. 3 is a schematic illustration of a neutron detector according to the present invention.

### DETAILED DESCRIPTION

The present invention provides methods and apparatuses for detecting neutrons, which provide high sensitivity, low cost, durability, portability, and scalability. Neutrons interacting with a ¹⁰B layer in the present invention result in expression of alpha particles from the ¹⁰B layer. The alpha particles can then be detected, for example with a silicon photodetector or an imaging array (e.g., arrays used in digital cameras).

Experimental work at Sandia National Laboratories (SNL) has shown that a solid ¹⁰B layer in combination with a CCD detector can be used to detect neutrons. In this work the researchers deposit the ¹⁰B layer on silicon. Since depositing thick layers of boron on silicon leads to delamination, the researchers used pulsed laser deposition (PLD) to deposit the necessary thick layer of boron. The present invention circumvents the use of the expensive PLD technique, by using a substrate that is compatible for boron deposition. Substrates that contain elements such as carbon, oxygen or nitrogen that have an affinity for boron can be used for deposition. These substrates have the ability to create a strong interfacial bond with boron that resists delamination when thick layers of boron are deposited. The present invention also can use off-the-shelf photodetectors instead of CCD detectors or CMOS detectors. Both off-the-shelf CCD and CMOS detectors have thick protective passivation layers on the detector surfaces. These layers significantly attenuate the signal from the alpha particle and reduce the sensitivity of the detector. In order to use these detectors, the passivation layer has to be etched down to a reasonable thickness which adds additional processing steps and hence adds cost to the manufacturing process. On the other hand, the photodetectors used with the present invention have very thin passivation layers and can hence be used without any modification.

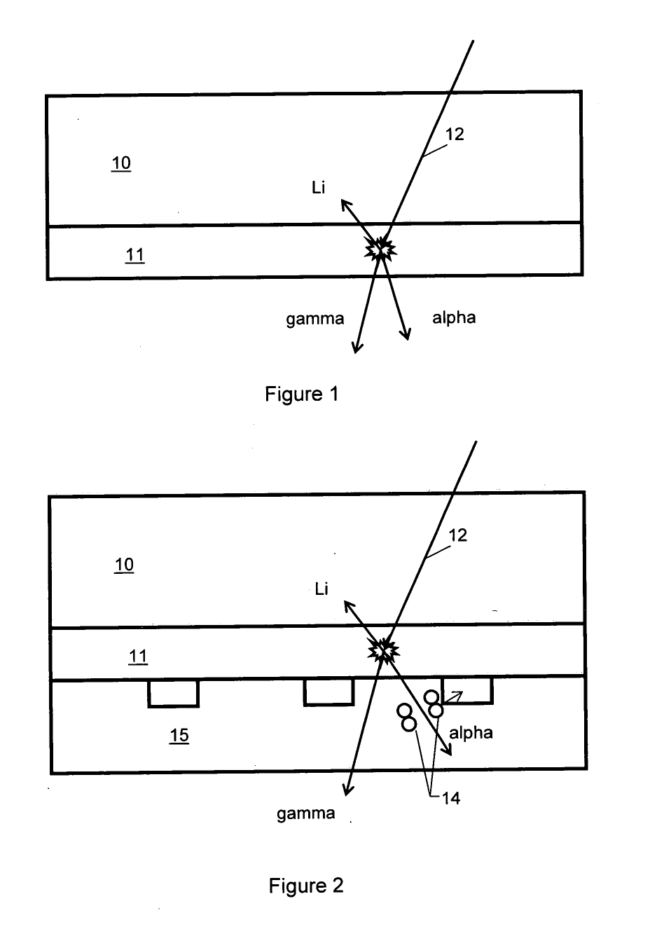

FIG. 1 is a schematic illustration of a neutron detector according to the present invention. A substrate 10 of a suitable material (as discussed below) mounts with a ¹⁰B layer 11. A thermal neutron 12 can traverse the substrate and interact with the ¹⁰B layer. The interaction of the neutron and the ¹⁰B layer is
¹⁰B+¹n=⁷Li+4α

The alpha particle expressed from the ¹⁰B layer can be detected as an indicator of the original neutron. An example detector arrangement is shown schematically in FIG. 2. An alpha particle interacts with the photodetector 15 which generally consists of a p/n or p/i/n junction. The alpha particle creates electrons and holes (represented in the figure by circles 14) near the junction of the photodetector which, in turn, generate a detectable current. It can be desirable that the detector have high sensitivity to alpha particles. The detector generally should not have a thick protective coating since the protective layer can also serve to block alpha particles. A coating of less than 200 nm is desirable. Off-the-shelf CCD and CMOS detectors have thick protective passivation layers that absorb a significant amount of the alpha particles. Off-the-shelf photodetectors can be obtained with the desired thin passivation layer.

Substrates suitable for use in the present invention must provide a bond with the ¹⁰B layer sufficient to resist delamination of the ¹⁰B layer. Suitably thick ¹⁰B layers, for example thicker than 1 micron, or thicker than 2 microns in some applications, can delaminate from many substrate materials. Also, to provide a suitably inexpensive detector, the indicated bond should be formed without requiring very high temperature processing (e.g., processing below about 300° C.).

Materials that are suitable substrates for the deposition of boron comprise an element that readily forms a compound with boron. Such elements include oxygen, carbon, nitrogen, phosphorous and arsenic. Substrates that contain one or more of these elements can foster better boron adhesion than substrates previously used. Examples of such substrates include silicon carbide, indium phosphide, gallium arsenide, sapphire, soda lime glass, borosilicate glass, etc. Since the substrate only acts as a template for the deposition of boron and does not need to serve any other purpose, a low quality poly-crystalline or even amorphous material can be used to lower the cost of the overall system. The quality of the substrate is not generally a critical factor for this application; in some embodiments, a rough, partially polished substrate can provide even better adhesion.

In cases where the substrate is unsuitable for the deposition of thick boron films, an intermediate layer that is more conducive for the adhesion of boron can be created by either deposition (especially in the case of elemental layer like carbon) or reaction (in the case of compounds such as oxides or nitrides). The intermediate layer will contain elements that promote adhesion such as carbon, nitrogen, oxygen, etc. For example, silicon is generally not a suitable substrate for the low temperature deposition of boron. However, the use of a thick silicon dioxide or silicon nitride or silicon carbide layer can promote adhesion with the boron layer. Once the intermediate layer is created, the deposition of thick layers of boron can be achieved.

The ¹⁰B layer can be deposited on a suitable substrate in an e-beam deposition system. The source comprises highly enriched (>90%) ¹⁰B pellets. The substrate can be cleaned with isopropyl alcohol and placed in the deposition system. Other cleaning methods that degrease the surface can also work. The pellets can be melted in a crucible using the e-beam with the shutter closed to avoid accidental deposition during the melting process. Once the melt is ready, the shutter is opened and the boron deposition is performed until the required thickness is achieved.

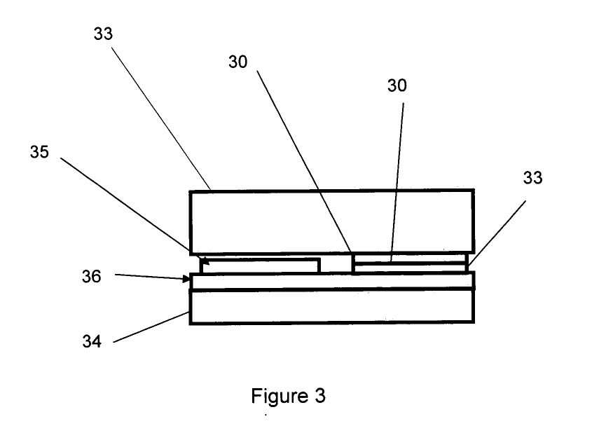

FIG. 3 is a schematic illustration of a neutron detector according to the present invention. A substrate 30, like those described above, mounts with a ¹⁰B layer 31 and a detector 32. The detector, substrate, and ¹⁰B layer can form a subassembly (e.g., a printed circuit board 36) that mounts with electronic circuitry 35 suitable for communicating signals from the detector with external outputs, for example with external alarms, displays, or recording systems. A moderator 33 mounts with the subassembly such that neutrons traversing the moderator can be slowed to enhance their interaction with the ¹⁰B layer. A moderator can be constructed of nuclear grade high density polyethylene (HDPE) which contains an abundance of hydrogen, the element with the highest neutron cross section and the material of choice in ³He and ¹⁰BF₃ detectors. A moderator can comprise high density polyethylene (HDPE). In some embodiments, a desirable thickness for use with a Cf252 source is about 1″ and the moderator can generally cover the entire detector surface. For some applications, the substrate and ¹⁰B layer can be about 1 square inch, and the overall detector assembly about 4 square inches in cross-section. An additional moderator 34 (e.g., up to 1″ thick) can be used on the back side of the detector chip to provide additional signal. A moderator can be designed using Monte Carlo N-Particle (MCNP) modeling software to optimize the generation of thermal neutrons for ²⁵²Cf neutron sources in consideration of American National Standards Institute (ANSI) and Illicit Trafficking Radiation Detection Assessment Program (ITRAP) standards which use ²⁵²Cf as a neutron source. Moderators can be optimally designed to detect a broad range of sources.

The particular sizes and equipment discussed above are cited merely to illustrate particular embodiments of the invention. It is contemplated that the use of the invention may involve components having different sizes and characteristics. It is intended that the scope of the invention be defined by the claims appended hereto.

We claim:

1) An apparatus for generating alpha particles responsive to neutrons interacting with the apparatus, comprising:
a) A substrate comprising a material that creates a chemical bond with the ¹⁰B layer, when processed at temperatures below about 300° C., of sufficient strength to resist delamination of a ¹⁰B layer from the substrate;
b) A layer of ¹⁰B greater than about 1 micron thick, bonded to the substrate.

2) An apparatus as in claim 1, wherein the substrate comprises a layer of a first material bonded to a second material.

3) An apparatus as in claim 1, wherein the substrate comprises a material that creates the indicated chemical bond when ¹⁰B is deposited on the substrate using e-beam deposition.

4) An apparatus as in claim 1, wherein the substrate comprises a compound of oxygen, nitrogen, carbon, or phosphorous.

5) An apparatus as in claim 1, wherein the substrate comprises sapphire.

6) An apparatus as in claim 1, wherein the substrate comprises soda lime glass or borosilicate glass

7) An apparatus for detecting neutrons, comprising:
a) A substrate comprising a material that creates a chemical bond with the ¹⁰B layer, when processed at temperatures below about 300° C., of sufficient strength to resist delamination of a ¹⁰B layer from the substrate;
b) A layer of ¹⁰B greater than about 1 micron thick, bonded to the substrate;
c) A detector that generates a signal responsive to an alpha particle interacting with the detector, mounted relative to the ¹⁰B layer such that at least some alpha particles expressed by the ¹⁰B layer responsive to a neutron interacting with the ¹⁰B layer can interact with the detector.

8) An apparatus as in claim 7, wherein the substrate comprises a layer of a first material bonded to a second material.

9) An apparatus as in claim 7, wherein the substrate comprises a material that creates the indicated chemical bond when ¹⁰B is deposited on the substrate using e-beam deposition.

10) An apparatus as in claim 7, wherein the substrate comprises a compound of oxygen, nitrogen, carbon, or phosphorous.

11) An apparatus as in claim 7, wherein the substrate comprises sapphire.

12) An apparatus as in claim 7, wherein the substrate comprises soda lime glass or borosilicate glass.

13) An apparatus as in claim 7, further comprising a moderator, mounted relative to the ¹⁰B layer such that at least some neutrons interacting with the ¹⁰B layer are first slowed by interaction with the moderator.

14) An apparatus as in claim 7, wherein the moderator comprises HDPE.

15) A method of making a neutron detector, comprising:
a) Providing a substrate;
b) Depositing a layer of ¹⁰B greater than about 1 micron thick on the substrate at temperatures less than about 300° C.;
c) Mounting a detector relative to the ¹⁰B layer such that at least some alpha particles expressed by the ¹⁰B layer responsive to a neutron interacting with the ¹⁰B layer can interact with the detector.

16) A method as in claim 15, wherein depositing a layer of ¹⁰B comprises depositing a layer of 10B using e-beam deposition.

17) A method as in claim 15, wherein providing a substrate comprises providing a substrate comprising a compound of oxygen, nitrogen, carbon, or phosphorous.

18) A method as in claim 15, wherein providing a substrate comprises providing a substrate comprising sapphire.

19) A method as in claim 15, wherein providing a substrate comprises providing a substrate comprising soda lime glass or borosilicate glass.

20) A method as in claim 15, further comprising mounting a moderator relative to the ¹⁰B layer such that at least some neutrons interacting with the moderator are slowed before interacting with the ¹⁰B layer.

21) An apparatus as in claim 1, wherein the ¹⁰B layer is greater than about 2 microns thick.

22) An apparatus as in claim 7, wherein the ¹⁰B layer is greater than about 2 microns thick.

23) A method as in claim 15, wherein a layer of ¹⁰B comprises depositing a layer of ¹⁰B greater than about 2 microns thick.

24) A method of detecting neutrons, comprising:
a) Providing a substrate having a ¹⁰B layer greater than about 1 micron thick deposited thereon;
b) Placing the substrate relative to a source of neutrons such that neutrons from the source interact with the ¹⁰B layer;
c) Detecting alpha particles expressed from the ¹⁰B layer responsive to interacting neutrons.
